(19) United States
(12) Patent Application Publication
(10) Pub. No.: US 2026/0099892 A1
(43) Pub. Date: Apr. 9, 2026

(54) Aggregating Graphics Processing Unit Resources in Containerized Applications

(71) Applicant: Dell Products L.P., Round Rock, TX (US)

(72) Inventor: Michael Marrotte, Windermere, FL (US)

(21) Appl. No.: 18/907,106

(22) Filed: Oct. 4, 2024

(51) Int. Cl. G06T 1/20

(52) U.S. Cl. CPC G06T 1/20

(57) ABSTRACT

A system can identify respective graphics processing units of respective computing nodes of a group of computing nodes with respect to which a containerized application operates. The system can virtualize the graphics processing units in a virtual node, to produce virtualized graphics processing units. The system can cause the virtual node to be available to a control application of a platform of the containerized application. The system can enable access to the virtualized graphics processing units by the containerized application via the virtual node.

### BACKGROUND

A computer application can generally be implemented with a containerized architecture.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can identify respective graphics processing units of respective computing nodes of a group of computing nodes with respect to which a containerized application operates. The system can virtualize the graphics processing units in a virtual node, to produce virtualized graphics processing units. The system can cause the virtual node to be available to a control application of a platform of the containerized application. The system can enable access to the virtualized graphics processing units by the containerized application via the virtual node.

An example method can comprise identifying, by a system comprising at least one processor, respective graphics processing units of respective nodes of a group of nodes, wherein a containerized application is configured to execute instructions with respect to the group of nodes. The method can further comprise virtualizing, by the system, the graphics processing units in a virtual node, to produce virtualized graphics processing units. The method can further comprise enabling, by the system, the virtual node to be available to a control application of a platform of the containerized application. The method can further comprise facilitating, by the system, access to the virtualized graphics processing units by the containerized application via the virtual node.

An example non-transitory computer-readable medium can comprise instructions that, in response to execution, cause a system comprising a processor to perform operations. These operations can comprise identifying respective processing units of respective nodes of a group of nodes, wherein a containerized application is configured to execute on the group of nodes. These operations can further comprise virtualizing the processing units in a virtual node, to produce virtualized processing units. These operations can further comprise making the virtual node available to a control application of a platform of the containerized application. These operations can further comprise enabling access to the virtualized processing units by the containerized application via the virtual node.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate aggregating graphics processing unit resources in containerized applications, in accordance with an embodiment of this disclosure;

FIG. 2 illustrates another example system architecture that can facilitate aggregating graphics processing unit resources in containerized applications, in accordance with an embodiment of this disclosure;

FIG. 3 illustrates an example process flow that can facilitate aggregating graphics processing unit resources in containerized applications, in accordance with an embodiment of this disclosure;

FIG. 4 illustrates another example process flow that can facilitate aggregating graphics processing unit resources in containerized applications, in accordance with an embodiment of this disclosure;

FIG. 5 illustrates another example process flow that can facilitate aggregating graphics processing unit resources in containerized applications, in accordance with an embodiment of this disclosure;

FIG. 6 illustrates another example process flow that can facilitate aggregating graphics processing unit resources in containerized applications, in accordance with an embodiment of this disclosure;

FIG. 7 illustrates another example process flow that can facilitate aggregating graphics processing unit resources in containerized applications, in accordance with an embodiment of this disclosure;

FIG. 8 illustrates another example process flow that can facilitate aggregating graphics processing unit resources in containerized applications, in accordance with an embodiment of this disclosure;

FIG. 9 illustrates another example process flow that can facilitate aggregating graphics processing unit resources in containerized applications, in accordance with an embodiment of this disclosure; and

FIG. 10 illustrates an example block diagram of a computer operable to execute an embodiment of this disclosure.

### DETAILED DESCRIPTION

### Overview

A containerized application can generally comprise a computer application (e.g., one that offers remote data storage to computer clients) that is architected with multiple application components that are configured to interact, each application component executing in a container. A container can generally comprise an isolated environment in which application computer code is executed, where the container additionally comprises components that the computer code depends on, such as libraries, frameworks, and/or configuration files.

The present techniques can facilitate virtualizing and aggregating graphics processing unit (GPU) GPU resources across multiple nodes within a containerized application cluster, enabling GPU-intensive workloads to perceive and utilize these resources as if they were on a single node. In some examples, by implementing a virtualization layer, custom device plugins, and middleware, the present techniques can abstract physical nodes into a unified logical node, optimizing resource utilization and improving performance for distributed GPU workloads.

That is, a result of implementing the present techniques can be that code running in a pod can seamlessly use all GPUs across multiple nodes of a cluster, just as it can on a single node.

A problem with prior approaches can be that traditional clusters can face limitations in efficiently managing and utilizing GPU resources across multiple nodes. GPU-intensive applications can require seamless access to aggregated GPU resources, which can be unsupported by current containerized application scheduling and resource management paradigms. This can lead to suboptimal performance, underutilization of available GPUs, and increased complexity in managing distributed workloads. The present techniques can address these challenges by providing a unified node abstraction, enabling efficient and scalable GPU resource aggregation in containerized application environments.

The present techniques can facilitate creating a unified node abstraction that aggregates GPU resources from multiple nodes, making them function as a single logical node in a containerized application. This can allow GPU-intensive workloads to utilize combined GPU resources seamlessly.

The present techniques can combine virtualization, custom resource definitions (CRDs), operators, and high-performance interconnects to present multiple nodes as a single entity. There can be a technical challenge of seamlessly integrating these components to provide unified GPU resource management and low-latency communication that is facilitated by the present techniques, and that has not been addressed by prior approaches.

There are prior approaches with bare metal deployments. These can offer high performance, but be challenging to scale dynamically. There are prior approaches with framework-specific clusters that use specialized tools. There are prior approaches with cloud virtual machine (VM) instances that can involve manual orchestration of GPU instances, which can be complex and operationally heavy. There can be prior approaches that virtualize GPUs but do not seamlessly integrate with a containerized application platform for multi-node aggregation.

Issues with prior approaches can include scalability (dynamic scaling can be difficult with bare metal, and require manual intervention), resource utilization (static allocation can lead to idle GPUs), management complexity (there can be high manual effort involved), and flexibility (it can be hard to adapt to workload changes).

There can be a prior approach with containerized applications that use distributed GPU training, dynamic scaling and resource management, standardized workflows (which can simplify machine learning (ML) pipeline management), and can be a heavy platform that includes many stacks so adds management complexity.

These prior approaches with containerized applications can fail to make multiple nodes function as a single node for GPU workloads. The present techniques can address this problem by virtualizing and aggregating GPU resources across nodes, presenting them as a unified entity to a containerized application platform, thereby optimizing (or improving) performance and resource utilization.

It can be that previous approaches to container orchestration systems were not designed to aggregate multiple nodes into a virtual node that can handle workloads that require more resources than a single node can provide. Rather, prior container orchestration systems largely followed a path of horizontal scaling, distributing workloads across multiple workers. This can make it less obvious that vertical scaling can be beneficial, but it also adds complexity for developers managing workloads that cannot easily be split across nodes. Virtualization technology for compute has traditionally focused on sharing resources rather than aggregating them - except in the case of storage (and some non-container orchestration system outliers). Current GPU cluster applications, for example, typically are not using container clusters and still follow the multiple worker model, hence they have a system that works for them. These kinds of workloads can fall outside the cloud-native, microservices model that container orchestration systems are built for. Aggregating compute resources across nodes can add even more complexity, which can be a reason why the container ecosystem has not implemented it.

Aggregating resources across multiple nodes can be inherently technically challenging due to the complexity of synchronizing resource coordination, managing distributed state, handling networking latency, and ensuring fault tolerance across disparate systems. Furthermore, it can be a fundamentally orthogonal design pattern from that of state-of-the-art container orchestration systems that focus on horizontal vs. vertical (virtual) scale-out.

### Example Architectures, Tables, and Flows

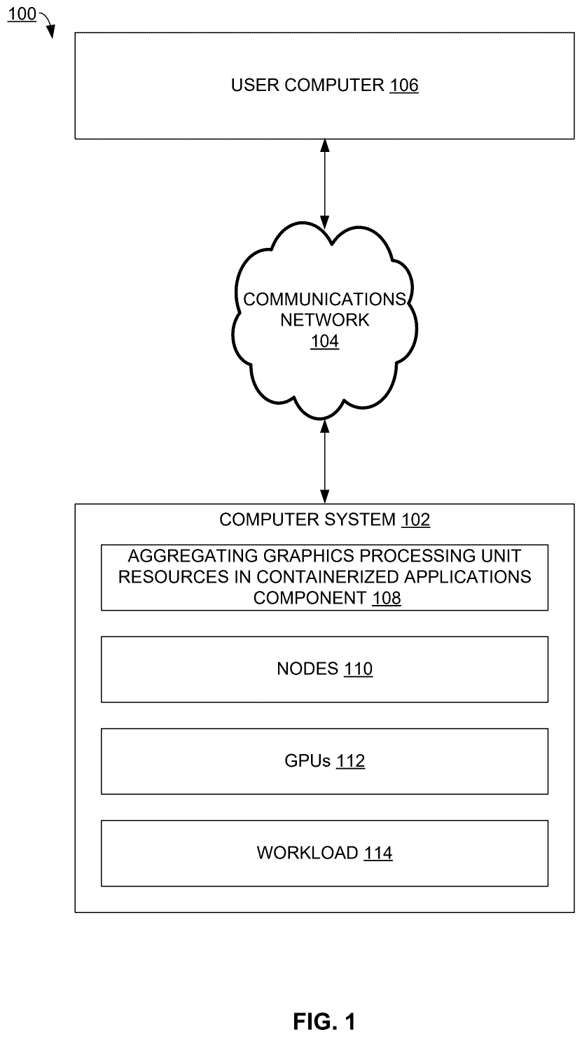

FIG. 1 illustrates an example system architecture 100 that can facilitate aggregating graphics processing unit resources in containerized applications, in accordance with an embodiment of this disclosure.

System architecture 100 comprises computer system 102, communications network 104, and user computer 106. In turn, computer system 102 comprises aggregating graphics processing unit resources in containerized applications component 108, computer system 102 (which can be referred to as a cluster), nodes 110, GPUs 112, and workload 114.

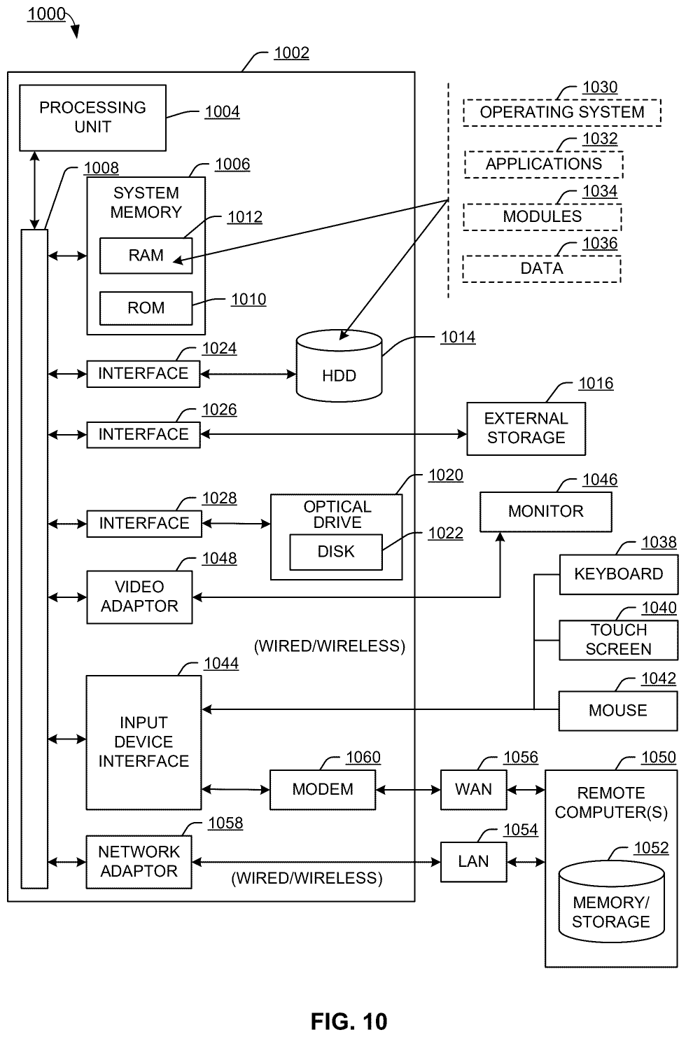

Each of computer system 102 and/or user computer 106 can be implemented with part(s) of computing environment 1000 of FIG. 10. Communications network 104 can comprise a computer communications network, such as the Internet, or an isolated private computer communications network.

User computer 106 can make a request to computer system 102 - via communications network 104 - to run workload 114 as a containerized application across nodes 110 (which can respectively comprise zero or more respective GPUs of GPUs 112). Workload 114 can comprise a workload that can utilize GPU resources.

Aggregating graphics processing unit resources in containerzing applications component 108 can virtualize the GPUs of GPUs 112 so that they can be collectively accessed in executing workload 114.

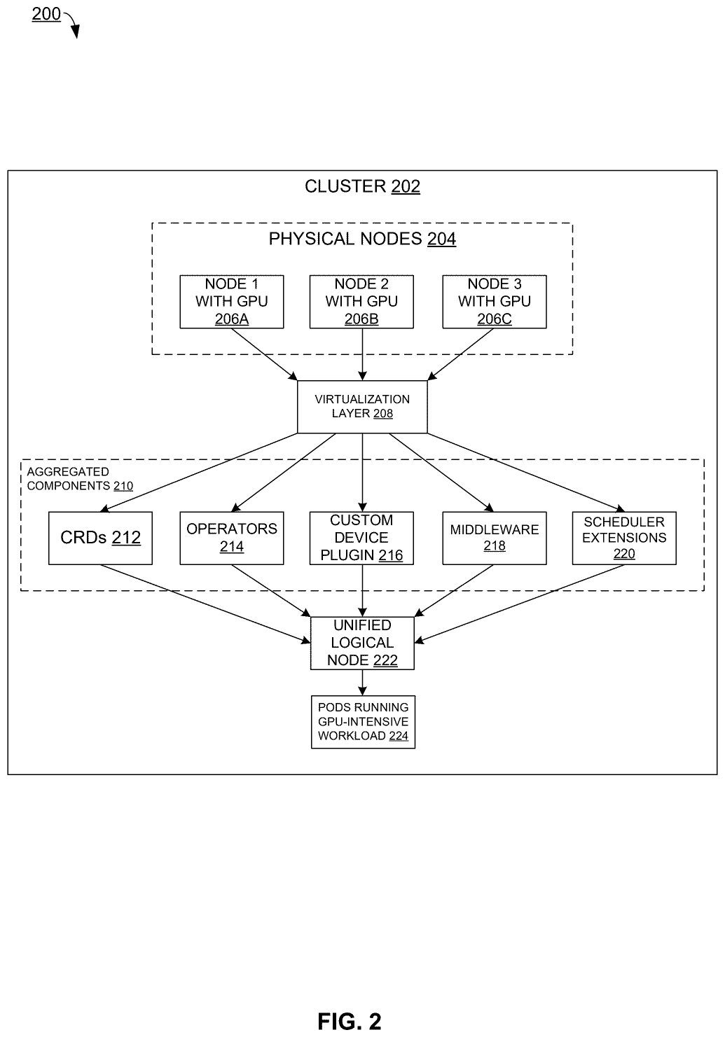

In some examples, aggregating graphics processing unit resources in containerized applications component 108 can implement part(s) of the process flows of FIGS. 2-9 to facilitate aggregating graphics processing unit resources in containerized applications.

It can be appreciated that system architecture 100 is one example system architecture for aggregating graphics processing unit resources in containerized applications, and that there can be other system architectures that facilitate aggregating graphics processing unit resources in containerized applications.

FIG. 2 illustrates another example system architecture 200 that can facilitate aggregating graphics processing unit resources in containerized applications, in accordance with an embodiment of this disclosure. In some examples, part(s) of system architecture 200 can be implemented by system architecture 100 of FIG. 1 to facilitate aggregating graphics processing unit resources in containerized applications.

System architecture 200 comprises cluster 202, physical nodes 204, node 1 with GPU 206A, node 2 with GPU 206B, node 3 with GPU 206C, virtualization layer 208, aggregated components 210, CRDs 212, operators 214, custom device plugin 216, middleware 218, scheduler extensions 220, unified logical node 222, and pods running GPU-intensive workload 224.

System architecture 200 comprises the following components, which, in some examples, can perform the following functions:

### Virtualization Layer:

Abstracts multiple physical nodes into a single logical node.
Uses high-performance interconnects for low-latency communication.

### Custom Resource Definitions (CRDs):

Defines the aggregated GPU resources and virtualized node configurations within a containerized application platform.

### Operators:

Manages the lifecycle of the virtualized node and aggregated GPU resources.
Automates resource allocation, scaling, and maintenance.

### Custom Device Plugins:

Manages and aggregates GPU resources across multiple nodes.
Presents the aggregated GPU resources as a single logical entity to the pods.

### Middleware:

Intercepts and manages application programming interface (API) calls so that workloads perceive a unified node.
Handles job distribution and resource monitoring.

### Scheduler Extension:

Enhances a containerized application scheduler to distribute workloads efficiently across the aggregated GPUs.
Ensures optimal performance and resource utilization.

According to the present techniques, the following can occur.

### Node Virtualization:

A virtualization layer abstracts physical nodes into a unified logical node.
High-performance interconnects ensure seamless communication.

### Resource Definition and Aggregation:

CRDs define the structure and configuration of the aggregated GPU resources.
Custom device plugins manage GPU aggregation across nodes.
Middleware handles API call interception and management.

### Operator Management:

Operators automate resource allocation, scaling, and lifecycle management.
Operators perform continuous monitoring of resource usage and performance.

### Workload Scheduling and Execution:

A scheduler extension allocates workloads across the aggregated GPUs.
Workloads run as if on a single node with access to all GPU resources.
Middleware can ensure consistent performance and resource utilization.

### Example Process Flows

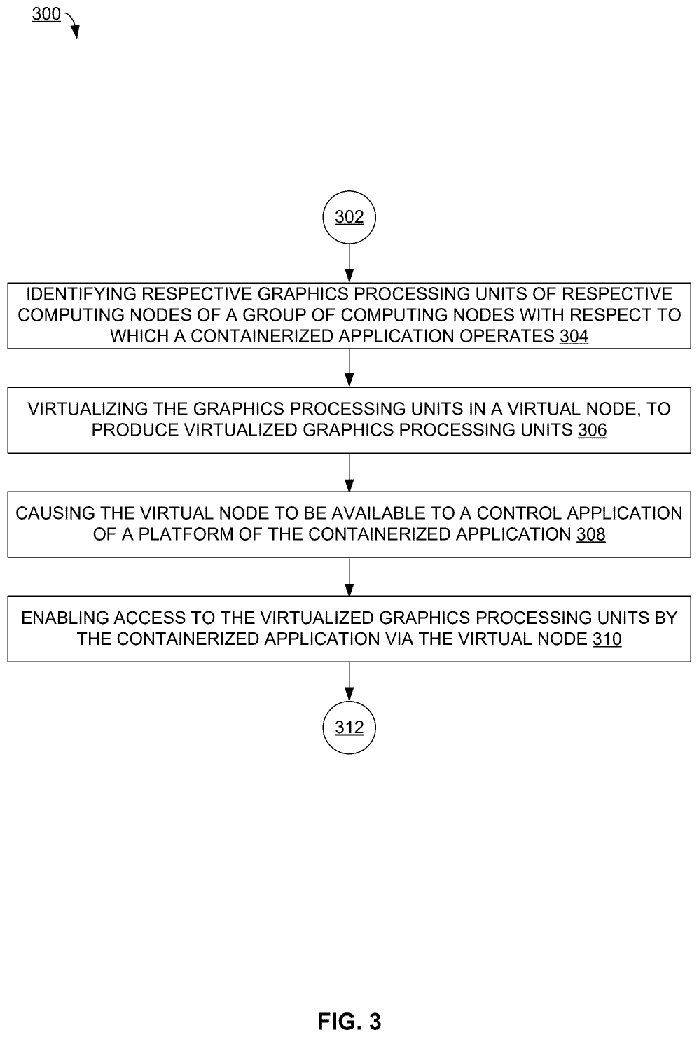

FIG. 3 illustrates an example process flow 300 that can facilitate aggregating graphics processing unit resources in containerized applications, in accordance with an embodiment of this disclosure. In some examples, one or more embodiments of process flow 300 can be implemented by system architecture 100 of FIG. 1, or computing environment 1000 of FIG. 10.

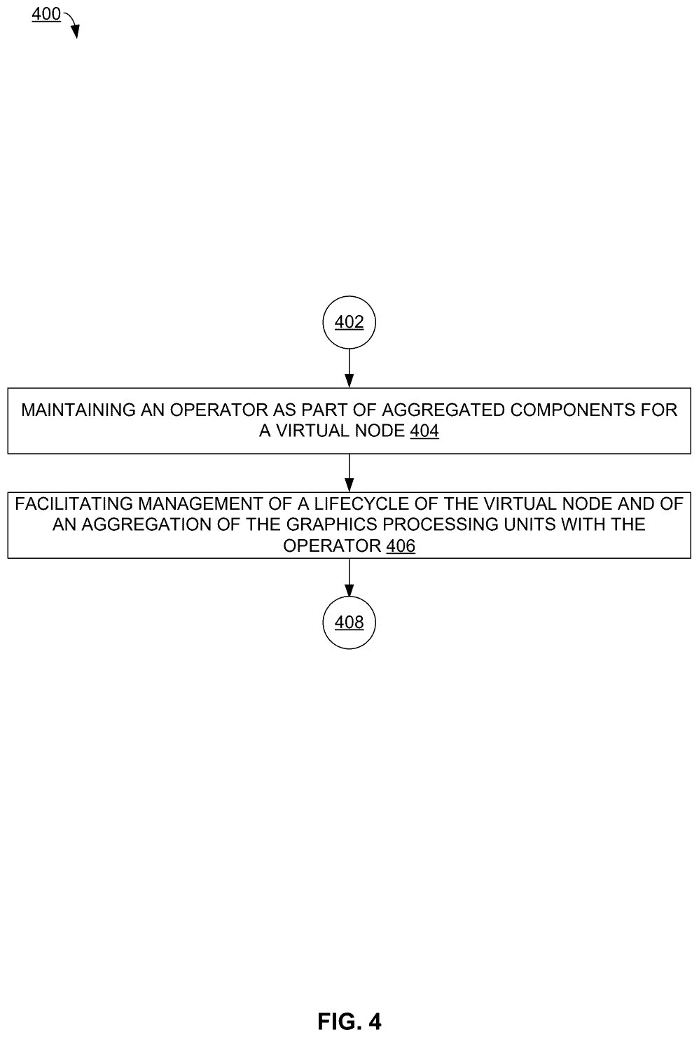

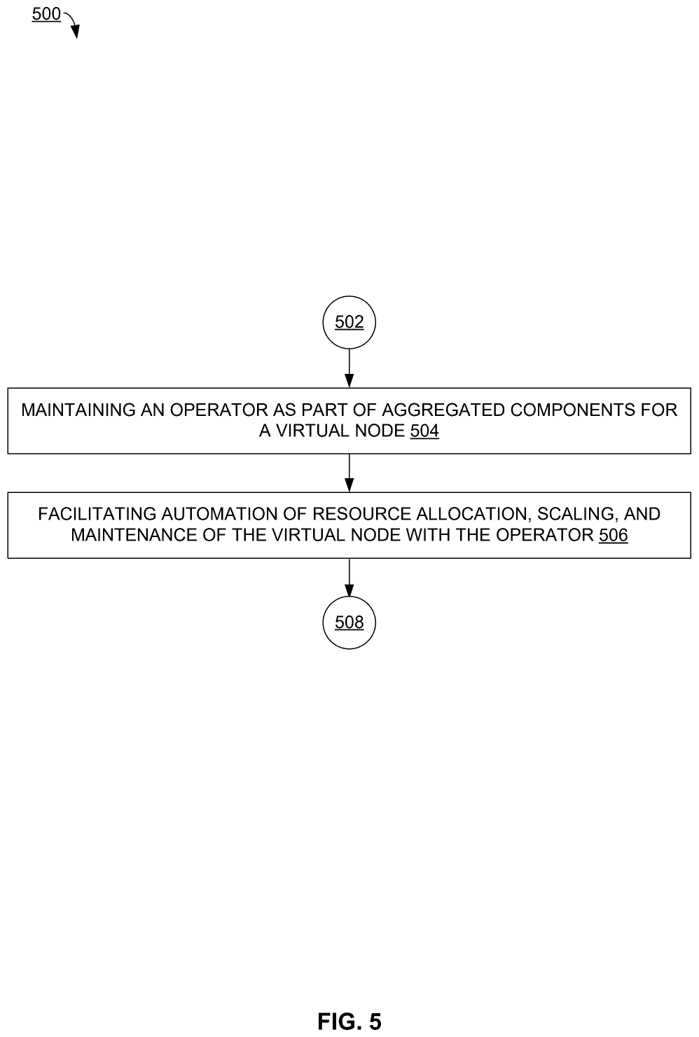

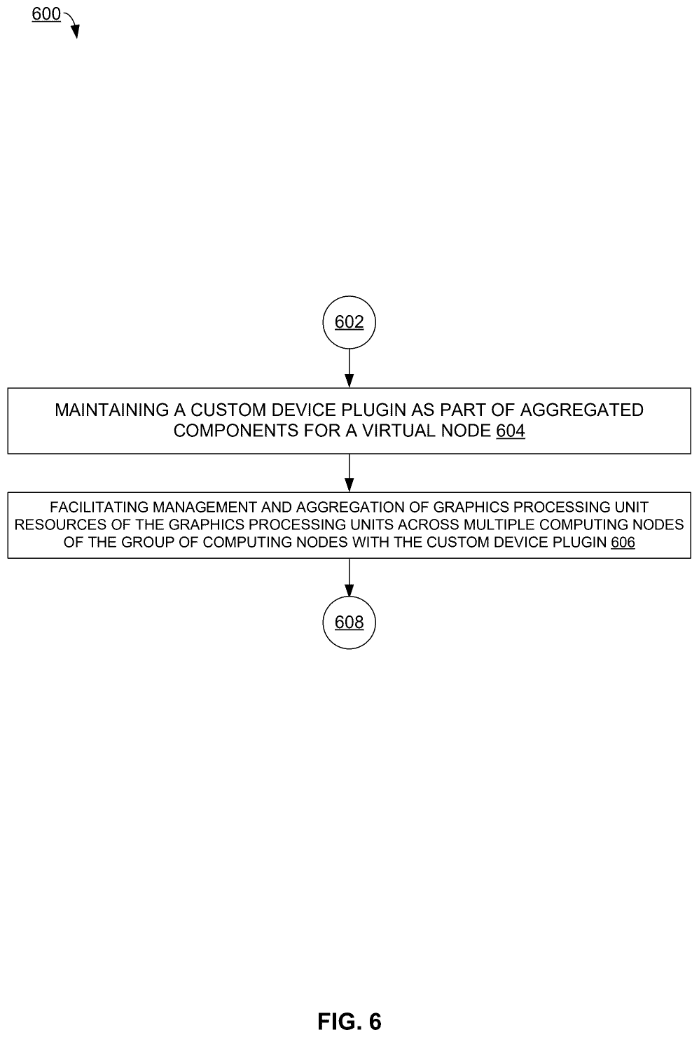

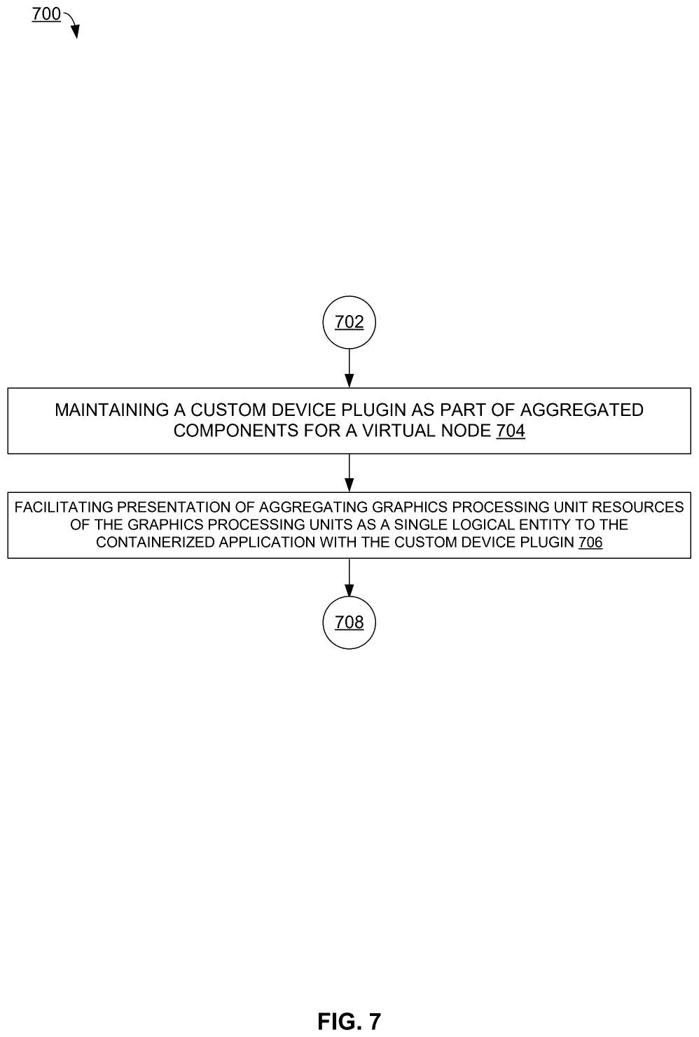

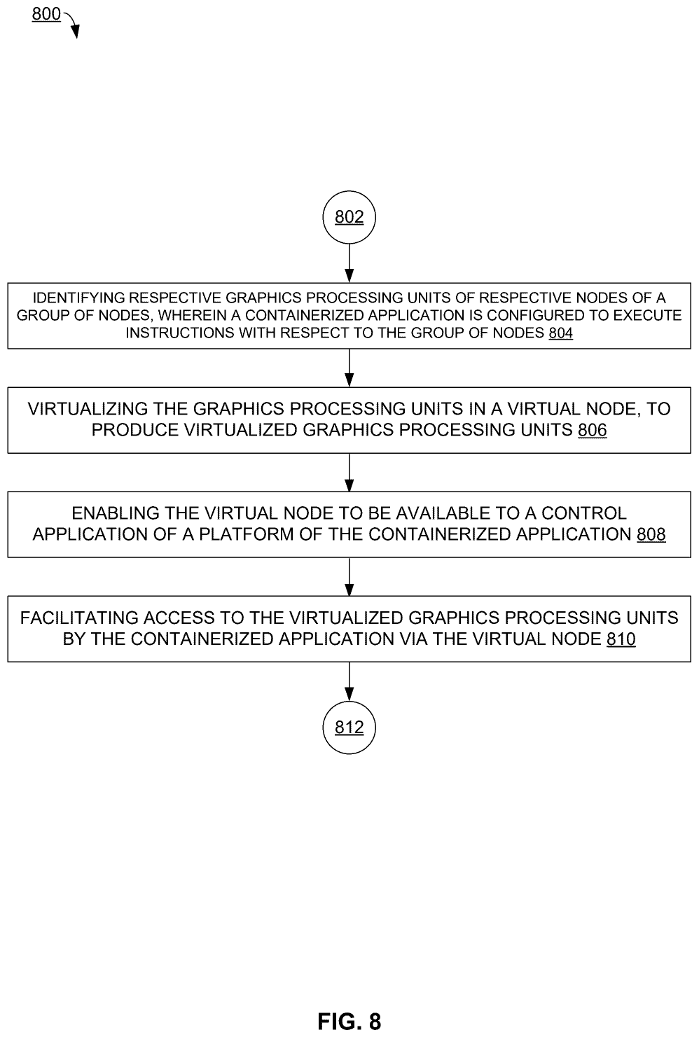

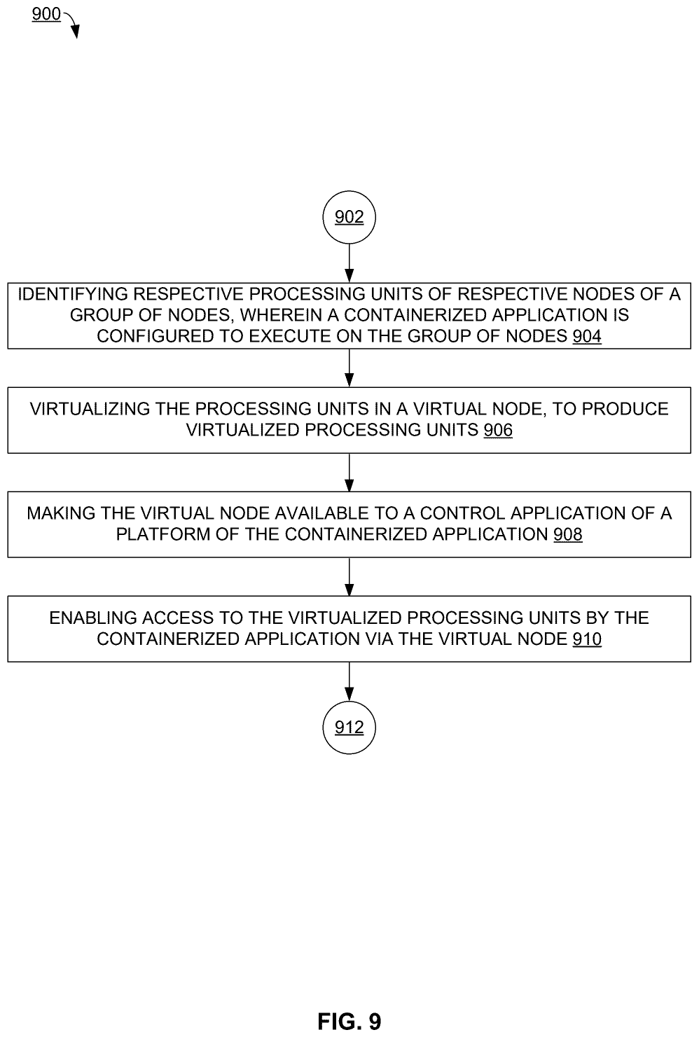

It can be appreciated that the operating procedures of process flow 300 are example operating procedures, and that there can be embodiments that implement more or fewer operating procedures than are depicted, or that implement the depicted operating procedures in a different order than as depicted. In some examples, process flow 300 can be implemented in conjunction with one or more embodiments of process flow 400 of FIG. 4, process flow 500 of FIG. 5, process flow 600 of FIG. 6, process flow 700 of FIG. 7, process flow 800 of FIG. 8, and/or process flow 900 of FIG. 9.

Process flow 300 begins with 302, and moves to operation 304.

Operation 304 depicts identifying respective graphics processing units of respective computing nodes of a group of computing nodes with respect to which a containerized application operates. That is, there can be a containerized application (e.g., workload 114 of FIG. 1) and a cluster of nodes on which the containerized application can execute (e.g., nodes 110 and/or cluster 202 of FIG. 2).

After operation 304, process flow 300 moves to operation 306.

Operation 306 depicts virtualizing the graphics processing units in a virtual node, to produce virtualized graphics processing units. Using the example of FIG. 2, cluster 202 can comprise physical nodes 204 that have GPUs, and these GPUs can be virtualized as part of unified logical node 222 (which can be a virtual node).

It can be that a system user can see all the nodes in the system and determine which ones have GPU. The user can select one or more nodes with a GPU to be a virtual node. For example, a cluster can have 12 nodes, where 8 of those nodes have a GPU. The user could select between 2 and 8 of those nodes to be part of the virtual node. The virtual node can be described/defined by a CRD and provisioned, configured, and life cycle managed by an operator.

In some examples, the virtual node comprises a custom resource definition. In some examples, the custom resource definition defines an aggregation of the graphics processing units, and a configuration of the virtual node within the control application. This can be a CRD similar to CRDs 212 of FIG. 2.

In some examples, the virtual node comprises an operator. In some examples, the operator facilitates management of a lifecycle of the virtual node and of an aggregation of the graphics processing units. In some examples, the operator facilitates automation of resource allocation, scaling, and maintenance of the virtual node. This operator can be similar to operators 214 of FIG. 2.

In some examples, the virtual node comprises a custom device plugin. In some examples, the custom device plugin facilitates management and aggregation of graphics processing unit resources of the graphics processing units across multiple computing nodes of the group of computing nodes. In some examples, the custom device plugin facilitates presentation of aggregating graphics processing unit resources of the graphics processing units as a single logical entity to the containerized application. This can be similar to custom device plugin 216 of FIG. 2.

After operation 306, process flow 300 moves to operation 308.

Operation 308 depicts causing the virtual node to be available to a control application of a platform of the containerized application. That is, the virtual node of operation 306 can be presented to an application that controls the containerized application (e.g., starting the containerized application, stopping the containerized application, and/or placing the containerized application on one or more physical nodes to execute).

After operation 308, process flow 300 moves to operation 310.

Operation 310 depicts enabling access to the virtualized graphics processing units by the containerized application via the virtual node. That is, the containerized application can use the graphics processing resources of multiple GPUs as they are collected and presented as a single virtualized GPU.

After operation 310, process flow 300 moves to 312, where process flow 300 ends.

FIG. 4 illustrates another example process flow 400 that can facilitate aggregating graphics processing unit resources in containerized applications, in accordance with an embodiment of this disclosure. In some examples, one or more embodiments of process flow 400 can be implemented by system architecture 100 of FIG. 1, or computing environment 1000 of FIG. 10.

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of process flow 300 of FIG. 3, process flow 500 of FIG. 5, process flow 600 of FIG. 6, process flow 700 of FIG. 7, process flow 800 of FIG. 8, and/or process flow 900 of FIG. 9.

Process flow 400 begins with 402, and moves to operation 404.

Operation 404 depicts maintaining an operator as part of aggregated components for a virtual node. Using the example of FIG. 2, the operator can be one of operators 214, the aggregated components can be aggregated components 210, and the virtual node can be unified logical node 222.

After operation 404, process flow 400 moves to operation 406.

Operation 406 depicts facilitating management of a lifecycle of the virtual node and of an aggregation of the graphics processing units with the operator. That is, an operator can manage the lifecycle of a virtualized node and aggregated GPU resources.

After operation 406, process flow 400 moves to 408, where process flow 400 ends.

FIG. 5 illustrates another example process flow 500 that can facilitate aggregating graphics processing unit resources in containerized applications, in accordance with an embodiment of this disclosure. In some examples, one or more embodiments of process flow 500 can be implemented by system architecture 100 of FIG. 1, or computing environment 1000 of FIG. 10.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of process flow 300 of FIG. 3, process flow 400 of FIG. 4, process flow 600 of FIG. 6, process flow 700 of FIG. 7, process flow 800 of FIG. 8, and/or process flow 900 of FIG. 9.

Process flow 500 begins with 502, and moves to operation 504.

Operation 506 depicts maintaining an operator as part of aggregated components for a virtual node. Using the example of FIG. 2, the operator can be one of operators 214, the aggregated components can be aggregated components 210, and the virtual node can be unified logical node 222.

After operation 504, process flow 500 moves to operation 506.

Operation 506 depicts facilitating automation of resource allocation, scaling, and maintenance of the virtual node with the operator. That is, an operator can automate resource allocation, scaling, and maintenance.

After operation 506, process flow 500 moves to 508, where process flow 500 ends.

FIG. 6 illustrates another example process flow 600 that can facilitate aggregating graphics processing unit resources in containerized applications, in accordance with an embodiment of this disclosure. In some examples, one or more embodiments of process flow 600 can be implemented by system architecture 100 of FIG. 1, or computing environment 1000 of FIG. 10.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of process flow 300 of FIG. 3, process flow 400 of FIG. 4, process flow 500 of FIG. 5, process flow 700 of FIG. 7, process flow 800 of FIG. 8, and/or process flow 900 of FIG. 9.

Process flow 600 begins with 602, and moves to operation 604.

Operation 604 depicts maintaining a custom device plugin as part of aggregated components for a virtual node. Using the example of FIG. 2, the custom device plugin can be custom device plugin 216, the aggregated components can be aggregated components 210, and the virtual node can be unified logical node 222.

After operation 604, process flow 600 moves to operation 606.

Operation 606 depicts facilitating management and aggregation of graphics processing unit resources of the graphics processing units across multiple computing nodes of the group of computing nodes with the custom device plugin. That is, a custom device plugin can manage and aggregate GPU resources across multiple nodes.

After operation 606, process flow 600 moves to 608, where process flow 600 ends.

FIG. 7 illustrates another example process flow 700 that can facilitate aggregating graphics processing unit resources in containerized applications, in accordance with an embodiment of this disclosure. In some examples, one or more embodiments of process flow 700 can be implemented by system architecture 100 of FIG. 1, or computing environment 1000 of FIG. 10.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of process flow 300 of FIG. 3, process flow 400 of FIG. 4, process flow 500 of FIG. 5, process flow 600 of FIG. 6, process flow 800 of FIG. 8, and/or process flow 900 of FIG. 9.

Process flow 700 begins with 702, and moves to operation 704.

Operation 704 depicts maintaining a custom device plugin as part of aggregated components for a virtual node. Using the example of FIG. 2, the custom device plugin can be custom device plugin 216, the aggregated components can be aggregated components 210, and the virtual node can be unified logical node 222.

After operation 704, process flow 700 moves to operation 706.

Operation 706 depicts facilitating presentation of aggregating graphics processing unit resources of the graphics processing units as a single logical entity to the containerized application with the custom device plugin. That is, a custom device plugin can present aggregated GPU resources as a single logical entity to a containerized application.

After operation 706, process flow 700 moves to 708, where process flow 700 ends.

FIG. 8 illustrates another example process flow 800 that can facilitate aggregating graphics processing unit resources in containerized applications, in accordance with an embodiment of this disclosure. In some examples, one or more embodiments of process flow 800 can be implemented by system architecture 100 of FIG. 1, or computing environment 1000 of FIG. 10.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of process flow 300 of FIG. 3, process flow 400 of FIG. 4, process flow 500 of FIG. 5, process flow 600 of FIG. 6, process flow 700 of FIG. 7, and/or process flow 900 of FIG. 9.

Process flow 800 begins with 802, and moves to operation 804.

Operation 804 depicts identifying respective graphics processing units of respective nodes of a group of nodes, wherein a containerized application is configured to execute instructions with respect to the group of nodes. In some examples, operation 804 can be implemented in a similar manner as operation 304 of FIG. 3.

In some examples, at least two nodes of the group of nodes are communicatively coupled via an interconnect that satisfies a high-performance criterion. That is, the nodes can be connected via high-performance interconnects.

After operation 804, process flow 800 moves to operation 806.

Operation 806 depicts virtualizing the graphics processing units in a virtual node, to produce virtualized graphics processing units. In some examples, operation 806 can be implemented in a similar manner as operation 306 of FIG. 3.

In some examples, the virtual node abstracts multiple nodes of the group of nodes into a single logical node. This can be similar to virtualization layer 208 of FIG. 2.

After operation 806, process flow 800 moves to operation 808.

Operation 808 depicts enabling the virtual node to be available to a control application of a platform of the containerized application. In some examples, operation 808 can be implemented in a similar manner as operation 308 of FIG. 3.

In some examples, the control application comprises middleware that is configured to intercept and manage application programming interface calls from the containerized application to facilitate presenting multiple nodes of the group of nodes to the containerized application as a unified node via the virtual node.

In some examples, a group of containerized applications comprises the containerized application, the control application comprises middleware that is configured to distribute jobs of the group of containerized applications across the group of nodes, and the middleware is configured to monitor resources of the group of nodes.

This middleware can be similar to middleware 218 of FIG. 2.

In some examples, a group of containerized applications comprises the containerized application, and the control application comprises a scheduler that is configured to distribute jobs of the group of containerized applications across the graphics processing units.

Middleware can ensure that workloads on a virtual node are distributed across multiple GPU as if all the GPU are running on the same node. A scheduler can schedule cluster submitted workloads onto virtual nodes as specified by workload spec requirements (e.g. a workload can specify that it desires to utilize 10 GPUs). The user can define a virtual node to those requirements that the workload is able to be scheduled, or it can trigger an auto-configuration of a virtual node to fulfill the requirements.

After operation 808, process flow 800 moves to operation 810.

Operation 810 depicts facilitating access to the virtualized graphics processing units by the containerized application via the virtual node. In some examples, operation 810 can be implemented in a similar manner as operation 310 of FIG. 3.

After operation 810, process flow 800 moves to 812, where process flow 800 ends.

FIG. 9 illustrates another example process flow 900 that can facilitate aggregating graphics processing unit resources in containerized applications, in accordance with an embodiment of this disclosure. In some examples, one or more embodiments of process flow 900 can be implemented by system architecture 100 of FIG. 1, or computing environment 1000 of FIG. 10.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of process flow 300 of FIG. 3, process flow 400 of FIG. 4, process flow 500 of FIG. 5, process flow 600 of FIG. 6, process flow 700 of FIG. 7, and/or process flow 800 of FIG. 8.

Process flow 900 begins with 902, and moves to operation 904.

Operation 904 depicts identifying respective processing units of respective nodes of a group of nodes, wherein a containerized application is configured to execute on the group of nodes. In some examples, operation 904 can be implemented in a similar manner as operation 304 of FIG. 3.

These processing units can be graphics processing units.

In some examples, at least one node of the group of nodes omits a processing unit. In some examples, at least one node of the group of nodes comprises multiple processing units of the processing units. That is, it can be that the nodes on which a workload can be scheduled are not homogenous - there can be a node that omits a GPU, a node that has one GPU, and a node that has multiple GPUs.

After operation 904, process flow 900 moves to operation 906.

Operation 906 depicts virtualizing the processing units in a virtual node, to produce virtualized processing units. In some examples, operation 906 can be implemented in a similar manner as operation 306 of FIG. 3.

In some examples, the virtual node comprises a custom resource definition.

In some examples, the virtual node comprises an operator.

After operation 906, process flow 900 moves to operation 908.

Operation 908 depicts making the virtual node available to a control application of a platform of the containerized application. In some examples, operation 908 can be implemented in a similar manner as operation 308 of FIG. 3.

After operation 908, process flow 900 moves to operation 910.

Operation 910 depicts enabling access to the virtualized processing units by the containerized application via the virtual node. In some examples, operation 910 can be implemented in a similar manner as operation 310 of FIG. 3.

After operation 910, process flow 900 moves to 912, where process flow 900 ends.

### Example Operating Environment

In order to provide additional context for various embodiments described herein, FIG. 10 and the following discussion are intended to provide a brief, general description of a suitable computing environment 1000 in which the various embodiments of the embodiment described herein can be implemented.

For example, parts of computing environment 1000 can be used to implement one or more embodiments of computer system 102 and/or user computer 106 of FIG. 1.

In some examples, computing environment 1000 can implement one or more embodiments of the process flows of FIGS. 3-9 to facilitate aggregating graphics processing unit resources in containerized applications.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a nonvolatile storage such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the. NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples, and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1016 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips...), optical discs (e.g., CD, DVD...), smart cards, and flash memory devices (e.g., card, stick, key drive...). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B”is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more”unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
identifying respective graphics processing units of respective computing nodes of a group of computing nodes with respect to which a containerized application operates;
virtualizing the graphics processing units in a virtual node, to produce virtualized graphics processing units;
causing the virtual node to be available to a control application of a platform of the containerized application; and
enabling access to the virtualized graphics processing units by the containerized application via the virtual node.

2. The system of claim 1, wherein the virtual node comprises a custom resource definition.

3. The system of claim 2, wherein the custom resource definition defines an aggregation of the graphics processing units, and a configuration of the virtual node within the control application.

4. The system of claim 1, wherein the virtual node comprises an operator.

5. The system of claim 4, wherein the operator facilitates management of a lifecycle of the virtual node and of an aggregation of the graphics processing units.

6. The system of claim 4, wherein the operator facilitates automation of resource allocation, scaling, and maintenance of the virtual node.

7. The system of claim 1, wherein the virtual node comprises a custom device plugin.

8. The system of claim 7, wherein the custom device plugin facilitates management and aggregation of graphics processing unit resources of the graphics processing units across multiple computing nodes of the group of computing nodes.

9. The system of claim 7, wherein the custom device plugin facilitates presentation of aggregating graphics processing unit resources of the graphics processing units as a single logical entity to the containerized application.

10. A method, comprising:
identifying, by a system comprising at least one processor, respective graphics processing units of respective nodes of a group of nodes, wherein a containerized application is configured to execute instructions with respect to the group of nodes;
virtualizing, by the system, the graphics processing units in a virtual node, to produce virtualized graphics processing units;
enabling, by the system, the virtual node to be available to a control application of a platform of the containerized application; and
facilitating, by the system, access to the virtualized graphics processing units by the containerized application via the virtual node.

11. The method of claim 10, wherein the control application comprises middleware that is configured to intercept and manage application programming interface calls from the containerized application to facilitate presenting multiple nodes of the group of nodes to the containerized application as a unified node via the virtual node.

12. The method of claim 10, wherein a group of containerized applications comprises the containerized application, wherein the control application comprises middleware that is configured to distribute jobs of the group of containerized applications across the group of nodes, and wherein the middleware is configured to monitor resources of the group of nodes.

13. The method of claim 10, wherein a group of containerized applications comprises the containerized application, and wherein the control application comprises a scheduler that is configured to distribute jobs of the group of containerized applications across the graphics processing units.

14. The method of claim 10, wherein the virtual node abstracts multiple nodes of the group of nodes into a single logical node.

15. The method of claim 10, wherein at least two nodes of the group of nodes are communicatively coupled via an interconnect that satisfies a high-performance criterion.

16. A non-transitory computer-readable medium comprising instructions that, in response to execution, cause a system comprising at least one processor to perform operations, comprising:
identifying respective processing units of respective nodes of a group of nodes, wherein a containerized application is configured to execute on the group of nodes;
virtualizing the processing units in a virtual node, to produce virtualized processing units;
making the virtual node available to a control application of a platform of the containerized application; and
enabling access to the virtualized processing units by the containerized application via the virtual node.

17. The non-transitory computer-readable medium of claim 16, wherein at least one node of the group of nodes omits a processing unit.

18. The non-transitory computer-readable medium of claim 16, wherein at least one node of the group of nodes comprises multiple processing units of the processing units.

19. The non-transitory computer-readable medium of claim 16, wherein the virtual node comprises a custom resource definition.

20. The non-transitory computer-readable medium of claim 16, wherein the virtual node comprises an operator.
